(19) United States
(12) Patent Application Publication
(10) Pub. No.: US 2023/0291156 A1
(43) Pub. Date: Sep. 14, 2023

(54) ENHANCED CONNECTOR POST FOR MAINTAINING A GROUND PATH

(71) Applicant: PPC BROADBAND, INC., East Syracuse, NY (US)

(72) Inventor: Jordan CAVINESS, Liverpool, NY (US)

(73) Assignee: PPC BROADBAND, INC., East Syracuse, NY (US)

(21) Appl. No.: 18/117,518

(22) Filed: Mar. 6, 2023

Related U.S. Application Data
(60) Provisional application No. 63/317,657, filed on Mar. 8, 2022.

(51) Int. Cl. H01R 24/40; H01R 9/05

(52) U.S. Cl. CPC H01R 24/40; H01R 9/0512; H01R 9/0524

(57) ABSTRACT

A coaxial connector that may include a connector portion, a coupler portion that may be configured to be coupled with the connector portion, and a post portion that may comprise a forward post portion and a rearward post portion that is configured to form an electrical ground path with the forward post portion during operation of the connector. The forward post portion may comprise a forward post engagement portion that is configured to engage a rearward post engagement portion of the rearward post portion such that the forward post portion and the rearward post portion are fixed relative to each other. The forward post engagement portion may be configured to engage the rearward post engagement portion to provide the electrical ground path between the forward post engagement portion and the rearward post engagement portion so as to provide a ground path that extends from an outer conductor of a coaxial cable through the forward and rearward post engagement portions and to the post portion.

### CROSS-REFERENCE TO RELATED APPLICATION

This application claims the benefit of U.S. Provisional Application No. 63/317,657 filed Mar. 8, 2022, the disclosure of which is hereby incorporated by reference herein in its entirety.

### BACKGROUND

The present invention relates generally to connectors for terminating coaxial cable. More particularly, the present invention relates to axially compressible connectors for coaxial cables that may include an electrically conductive post.

Coaxial cables are commonly used in the cable television industry to carry cable TV signals to television sets in homes, businesses, and other locations.

Exemplary flexible coaxial cables include a solid wire core or inner conductor, typically of copper or copper-clad aluminum, surrounded by a flexible tubular outer conductor. The outer conductor is also usually made of woven copper or aluminum. Dielectric material or insulation separates the inner and outer conductors. The outer conductor is covered with a cable jacket or sheath of plastic to provide protection against corrosion and weathering.

The ability of a connector to make a solid ground connection to the outer conductor of a device is required to achieve long term performance as well as facilitate proper signal transmission through the connector with minimal loss or disruption of the signal. It may be desirable to provide a connector that provides a secure contact between outer conductors in drop connectors and in coaxial connections to devices such as cable TV boxes, modems, and the like.

Some connectors have an electrically conductive post that makes an electrically conductive ground connection with the outer conductor of the coaxial cable. The electrically conductive post can be a complicated shape that is difficult to produce. It may be desirable to provide a connector that overcomes one or more of the aforementioned disadvantages of connectors. That is, it may be desirable to provide a connector having a two-piece post that provides a secure electrically conductive connection between the outer conductor of the coaxial cable and the housing of the coupler.

It may be desirable to provide a coaxial connector having a forward post engagement portion that may be configured to engage a rearward post engagement portion so as to provide an electrical ground path between the forward post engagement portion and the rearward post engagement portion so as to provide a ground path from an outer conductor of a coaxial cable through the forward and rearward post engagement portions and to a post portion of the connector.

### SUMMARY

The present disclosure is directed to a coaxial connector that may include a forward engagement portion that may be configured to engage a rearward engagement portion so as to provide an electrical ground path between the forward engagement portion and the rearward engagement portion that may extend from an outer conductor of a coaxial cable through the forward and rearward engagement portions and to a post portion of the connector. The coaxial connector may include a connector body that may have a rearward cable receiving end and a forward end opposite the rearward cable receiving end, a coupler that may be configured to be coupled with the forward end of the connector body, and a post portion that may be supported in at least a portion of the connector body. The post portion may comprise a forward post portion and a rearward post portion; the forward post portion and the rearward post portion may be configured to be coupled to one another so as to provide an electrical ground path between the forward post portion and the rearward post portion. The forward post portion may comprise a forward post engagement portion, and the rearward post portion may comprise a rearward post engagement portion. The forward post engagement portion may be configured to engage the rearward post engagement portion such that the forward post portion and the rearward post portion may be fixed relative to each other. The forward post engagement portion may be configured to extend circumferentially around at least a portion of the forward post portion. The rearward post engagement portion may be configured to extend from the rearward post portion. The rearward post portion may have a rearward post anti-rotation feature. The forward post portion may have a forward post anti-rotation feature that may be configured to engage the rearward post anti-rotation feature so as to restrain the rearward post portion from rotating relative to the forward post portion. The forward post portion may include a main portion that has an inner forward post surface that is configured such that a forward inner circumference of the inner forward post surface of the main portion of the forward portion is equal to a rearward inner circumference of an inner rearward post surface of a main portion of the rearward post portion. The rearward post portion may include a cable engagement feature on an outer circumference of the rearward post portion that is configured to engage a cable received in the cable receiving end of the connector body. The forward post engagement portion may be configured to engage the rearward post engagement portion so as to provide the electrical ground path between the forward post engagement portion and the rearward post engagement portion so as to provide a ground path from an outer conductor of a coaxial cable through the forward and rearward post engagement portions and to the post portion.

In particular embodiments, the forward engagement portion may comprise an engagement protrusion.

In particular embodiments, the rearward engagement portion may comprise an engagement recess.

In particular embodiments, the forward engagement portion may be configured to extend circumferentially around at least an outer surface portion of the forward post portion and extend radially outward from the outer surface of the forward post portion, and the rearward post engagement portion may be configured to extend circumferentially relative to an inner surface of the rearward portion.

In particular embodiments, the rearward engagement portion may comprise a plurality of flexible sections that are configured to flex in a radial direction.

In particular embodiments, the rearward engagement portion may include a flexible section that is configured to flex radially outward. The flexible section may comprise a plurality of flexible sections that each may be separated in a circumferential direction by a plurality of slots.

In particular embodiments, the flexible section may be configured to flex in the radial direction so as to allow the rearward post engagement portion to move radially over the forward post engagement portion into a fully engaged position with the forward post engagement portion.

In particular embodiments, the ground path from an outer conductor of a coaxial cable through the forward and rearward post engagement portions and to the post portion may comprise a continuous ground path and/or a non-intermittent ground path.

The present disclosure provides a coaxial connector having a forward engagement portion configured to engage a rearward engagement portion to provide an electrical ground path between the forward engagement portion and the rearward engagement portion that may extend from an outer conductor of a coaxial cable through the forward and rearward engagement portions and to a post portion of the connector. The connector may include a connector portion having a rearward cable receiving end and a forward end opposite the rearward cable receiving end, a coupler portion configured to be coupled with the forward end of the connector portion, and a post portion that is configured to supported in at least a portion of the connector portion and comprising a forward post portion and a rearward post portion. A connection between the forward post portion and the rearward post portion may be configured to provide an electrical ground path between the forward post portion and the rearward post portion. The forward post portion comprises a forward engagement portion that is configured to engage a rearward engagement portion of the rearward post portion such that the forward post portion and the rearward post portion are fixed relative to each other. A forward inner circumference of a forward inner surface of a main portion of the forward post portion is equal to a rearward inner circumference of a rearward inner surface of a main portion of the rearward post portion; and the forward engagement portion is configured to engage the rearward engagement portion to provide the electrical ground path between the forward engagement portion and the rearward engagement portion so as to provide a ground path from an outer conductor of a coaxial cable through the forward and rearward engagement portions and to the post portion.

In particular embodiments, the forward post engagement portion may be configured to extend circumferentially around at least a portion of the forward post portion.

In particular embodiments, the rearward post engagement portion may be configured to extend from the rearward post portion.

In particular embodiments, the rearward post portion may have a rearward post anti-rotation feature; and the forward post portion may have a forward post anti-rotation feature that may be configured to engage the rearward post anti-rotation feature so as to restrain the rearward post portion from rotating relative to the forward post portion.

In particular embodiments, the rearward post portion may include a cable engagement feature on an outer circumference of the rearward post portion that is configured to engage a cable received in the cable receiving end of the connector body.

In particular embodiments, the forward post engagement portion may include an engagement protrusion, and the rearward post engagement portion may include an engagement recess.

In particular embodiments, the rearward post engagement portion may comprise a plurality of flexible sections that are configured to flex in a radial direction, and the plurality of flexible sections may be separated in a circumferential direction by a plurality of slots.

In particular embodiments, the flexible sections may be configured to flex in the radial direction so as to allow the rearward post engagement portion to move radially over the forward post engagement portion into a fully engaged position with the forward post engagement portion.

In particular embodiments, the ground path from an outer conductor of a coaxial cable through the forward and rearward post engagement portions and to the post portion may comprise a continuous ground path and/or a non-intermittent ground path.

The present disclosure provides a coaxial connector having a forward engagement portion configured to engage a rearward engagement portion to provide an electrical ground path between the forward engagement portion and the rearward engagement portion that may extend from an outer conductor of a coaxial cable through the forward and rearward engagement portions and to a post portion of the connector. The connector may include a connector portion, a coupler portion configured to be coupled with the connector portion, and a post portion comprising a forward post portion and a rearward post portion. A connection between the forward post portion and the rearward post portion may be configured to provide an electrical ground path. The forward post portion comprises a forward post engagement portion that is configured to engage a rearward post engagement portion of the rearward post portion such that the forward post portion and the rearward post portion are fixed relative to each other. The forward post engagement portion may be configured to engage the rearward post engagement portion so as to provide the electrical ground path between the forward post engagement portion and the rearward post engagement portion so as to provide a ground path from an outer conductor of a coaxial cable through the forward and rearward post engagement portions and to the post portion.

In particular embodiments, a forward inner circumference of a forward inner surface of a main portion of the forward post portion is equal to a rearward inner circumference of a rearward inner surface of a main portion of the rearward post portion.

In particular embodiments, the rearward post portion has a rearward anti-rotation feature; and the forward post portion has a forward anti-rotation feature that engages the rearward anti-rotation feature so as to restrain the rearward post portion from rotating relative to the forward post portion.

In particular embodiments, the rearward post engagement portion may comprise a plurality of flexible sections that are configured to flex in a radial direction, and the plurality of flexible sections may be separated in a circumferential direction by a plurality of slots.

In particular embodiments, the flexible sections may be configured to flex in the radial direction so as to allow the rearward post engagement portion to move radially over the forward post engagement portion into a fully engaged position with the forward post engagement portion.

In particular embodiments, the ground path from an outer conductor of a coaxial cable through the forward and rearward post engagement portions and to the post portion may comprise a continuous ground path and/or a non-intermittent ground path.

Various aspects of the coaxial connector, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a side cross-sectional view of a coaxial connector.

FIG. 2 is a side view of an exemplary coaxial connector in accordance with various aspects of the disclosure.

FIG. 3 is a side cross-sectional view of the coaxial connector of FIG. 2.

FIG. 4 is a side cross-sectional view of the coaxial connector of FIG. 3 with a coaxial cable installed.

FIG. 5 is a perspective sectional view of the coaxial connector of FIG. 4.

FIG. 6 is a perspective sectional view of the coaxial connector of FIG. 3.

FIG. 7 is an enlarged view of area VII in FIG. 6.

FIG. 8 is a side view of a post in accordance with aspects of the disclosure.

FIG. 9 is a side view of the post of FIG. 8 with the two parts of the post separated.

FIG. 10 is a side cross-sectional view of the post of FIG. 8.

FIG. 11 is a side sectional view of a first part of the post of FIG. 8.

FIG. 12 is a side sectional view of a second part of the post of FIG. 8.

FIG. 13 is a perspective view of the post of FIG. 8 showing the first and second parts connected.

FIG. 14 is a perspective view of the post of FIG. 8 showing the first and second parts separated.

FIG. 15 is a perspective sectional view of the post of FIG. 8 showing the first and second parts separated.

FIG. 16 is an enlarged partial view of the post of FIG. 15.

FIG. 17 is a perspective sectional view of the post of FIG. 8 showing the first and second parts connected.

FIG. 18 is a partial perspective view of an alternate post in accordance with aspects of the disclosure.

FIG. 19 is a partial sectional perspective view of the post of FIG. 18 showing the first and second parts connected.

FIG. 20 is a partial sectional view of the post of FIG. 18 showing the first and second parts connected.

### DETAILED DESCRIPTION OF EMBODIMENTS

Embodiments of the disclosure provide a coaxial connector having a forward post engagement portion that may be configured to engage a rearward post engagement portion so as to provide an electrical ground path between the forward post engagement portion and the rearward post engagement portion so as to provide a ground path from an outer conductor of a coaxial cable through the forward and rearward post engagement portions and to a post portion of the connector.

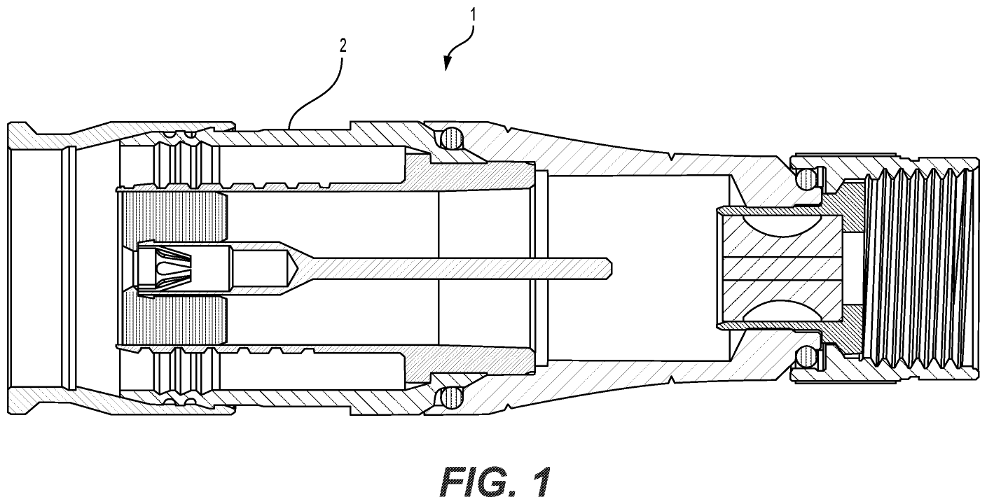

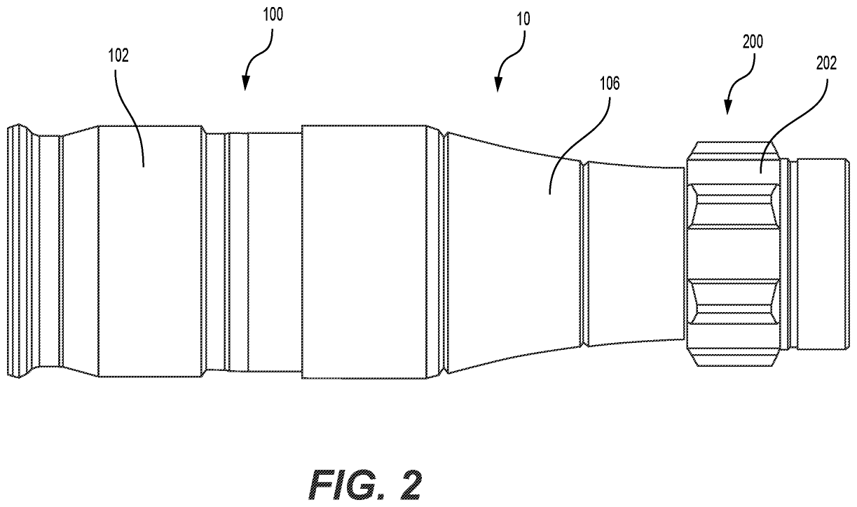

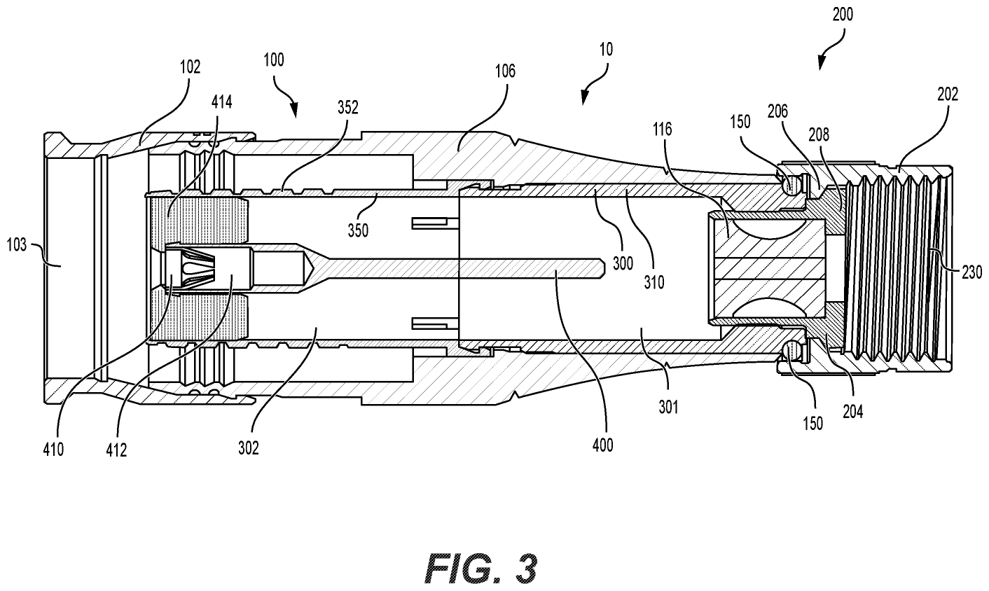

FIG. 1 is a side view of a conventional coaxial connector 1. In the connector shown in FIG. 1, a rear body portion 2 can be plastic, metal, or another material. FIG. 2 shows a side view of an exemplary connector assembly 10 in accordance with various aspects of the disclosure is illustrated. FIG. 3 shows a sectional view of the connector assembly 10. The connector assembly 10 includes a connector 100 and a coupler 200 that are configured to be connected to one another while providing both an electrical and mechanical connection therebetween. In an assembled position, as shown in FIGS. 2 and 3, the coupler 200 has internal threads 230 configured to be threaded onto an interface port (not shown) to hold the connector assembly 10 and the interface port together such that an electrical and mechanical connection is securely maintained.

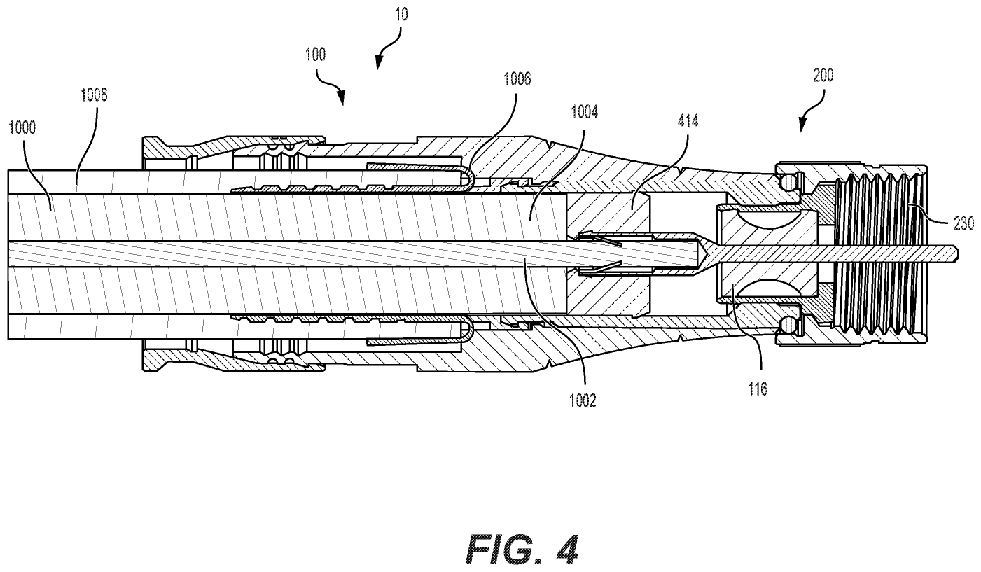

FIGS. 2 and 3 show an example of various features of the connector assembly 10. As shown in FIGS. 2 and 3, a compression ring 102 at a rearward end of the connector 100 has an opening 103 configured to receive a coaxial cable 1000 (see FIG. 4). The coaxial cable 1000 generally includes a solid center conductor 1002 typically formed from a conductive metal, such as copper, copper clad aluminum, copper clad steel, or the like capable of conducting electrical signals therethrough. Surrounding the cable center conductor 1002 is a cable dielectric 1004, which insulates the cable center conductor 1002 to minimize signal loss. The cable dielectric 1004 also maintains a spacing between the cable center conductor 1002 and a cable outer conductor or shield 1006. The cable dielectric 1004 is often a plastic material, such as a polyethylene, a fluorinated plastic material, such as a polyethylene or a polytetrafluoroethylene, a fiberglass braid, or the like. The cable shield 1006 or outer conductor is typically flexible and made of metal, such as aluminum or copper braid. An insulative cable jacket 1008 may surround the cable outer conductor 1006 to further seal the coaxial cable 1000. The cable jacket 1008 is typically made of plastic, such as polyvinylchloride, polyethylene, polyurethane, or polytetrafluoroethylene.

The connector 100 includes a plurality of components generally having a coaxial configuration about an axis defined by the center conductor 1002 of the coaxial cable 1000. A nose portion 106 receives a post 300 in an axial bore from a rearward direction which is opposite to the coupler 200. The nose portion 106 can be an electrically conductive material such as aluminum, brass, or the like, or the nose portion 106 can be a non-conductive material such as, for example, a non-conductive plastic. The post 300 is an electrically conductive material such as aluminum, brass, or the like. In this example, the post has a forward portion 310 and a rearward portion 350. The forward portion 310 is predominantly cylindrical in shape and includes an axial bore 301. The rearward portion 350 is predominantly cylindrical in shape and includes an axial bore 302.

The forward portion 310 has an opening 314 that is configured to receive an insert 204 at its forward end. In this example, the insert 204 can be any conductive material such as, for example, metal, a conductive plastic/polymer, or other conductive material. The insert 204 is configured to receive a dielectric insulator 116 such that movement in the forward direction of the dielectric insulator 116 is limited by the insert 204. The rearward portion 350 has along a portion of its length an engagement feature 352. In this example, the engagement feature 352 is helical in shape to facilitate twisting the coaxial cable 1000 onto the rearward portion 350. When the coaxial cable is inserted into connector 100, a majority of the rearward portion 350 penetrates the coaxial cable 1000 between the cable dielectric 1004 and the cable outer conductor or shield 1006 and the engagement feature 352 grips the cable outer conductor or shield 1006. In an assembled state, the rearward portion 350 forms an electrically conductive connection with the outer conductor or shield 1006. The forward portion 310 extends at least partially into the nose portion 106 and a knurled or other engaging interface can exist between the nose portion 106 and the forward portion 310 to prevent the forward portion 310 from rotating relative to the nose portion 106.

The compression ring 102 extends axially partially onto the nose portion 106. The connector 100 includes a pin 400 that is received in a dielectric insulator 116 that is located in the insert 204. The pin 400 has a center conductor connector 410 (such as a Mill-max connector) configured to receive and make an electrically conductive connection with the cable center conductor of the coaxial cable. In an assembled state, the cable center conductor extends into a bore 412 of the pin 400. A rear portion of the pin 400 is held in place by a dielectric insert 414 that moves within the rearward portion 350 with the pin 400.

FIG. 4 shows a coaxial cable in place in the connector assembly 10. During connection of the coaxial cable 1000 to the connector 100, the coaxial cable 1000 is inserted into the opening 103 in the compression ring 102 and into contact with the rearward portion 350 of the post 300. The leading edge of the rearward portion 350 separates the cable outer conductor or shield 1006 from the cable dielectric 1004. As the coaxial cable 1000 is further inserted into the connector 100, the cable center conductor 1002 enters the center conductor connector 410 and the bore 412. In the assembled state, an electrically conductive path is formed from the cable center conductor 1002 through center conductor connector 410 and the pin 400. In the assembled state, an electrically conductive path is formed from the cable outer conductor or shield 1006 through the rearward portion 350, the forward portion 310, and the nose portion 106.

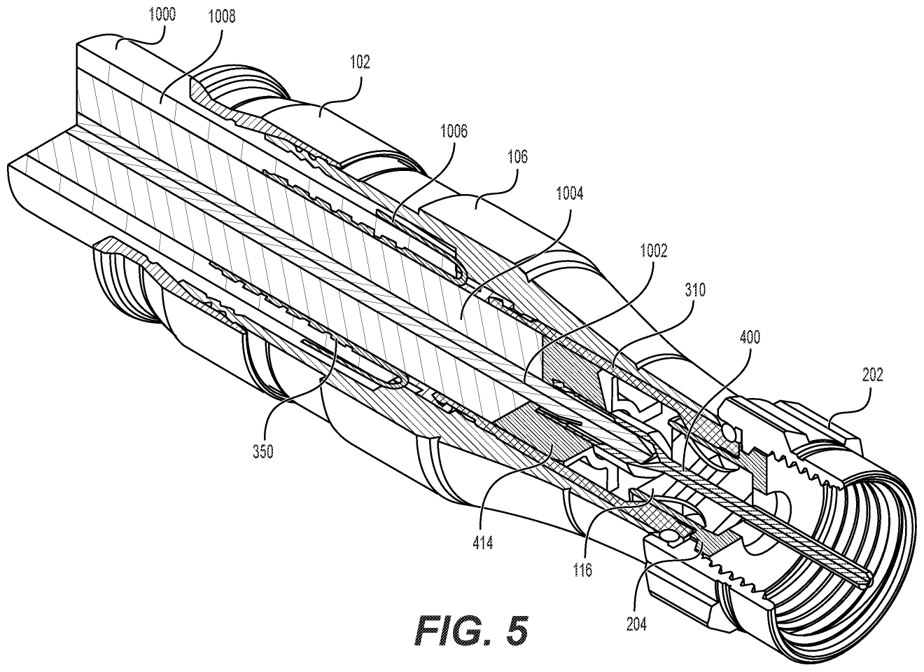

In this example, an O-ring 150 is located between the coupler 200 and the forward portion 310 to provide additional protection from moisture and other contaminants. The coupler 200 has a main body 202 that includes an inward radial protrusion 206 that extends from the main body 202 in an inward radial direction. The insert 204 has a lip 208 at its forward end that extends radially outward. An inner diameter of the inward radial protrusion 206 is smaller than an outer diameter of the lip 208 such that the lip 208 prevents the coupler 200 from disengaging from the connector 100. In this example, the insert 204 is press fit, or otherwise connected, to the forward portion 310 such that the insert 204 is fixed relative to the forward portion 310. In this example, the forward portion 310 is press fit, or otherwise connected, to the nose portion 106 such that the forward portion 310 is fixed relative to the nose portion 106. As a result, after assembly, the coupler 200 is retained by the insert 204 such that the coupler 200 remains attached to the connector 100. The coupler main body 202 can rotate relative to the insert 204 in order to permit the coupler main body 202 to be threaded onto an interface port. FIG. 5 shows a perspective sectional view of the connector assembly 10 with the coaxial cable 1000 in place.

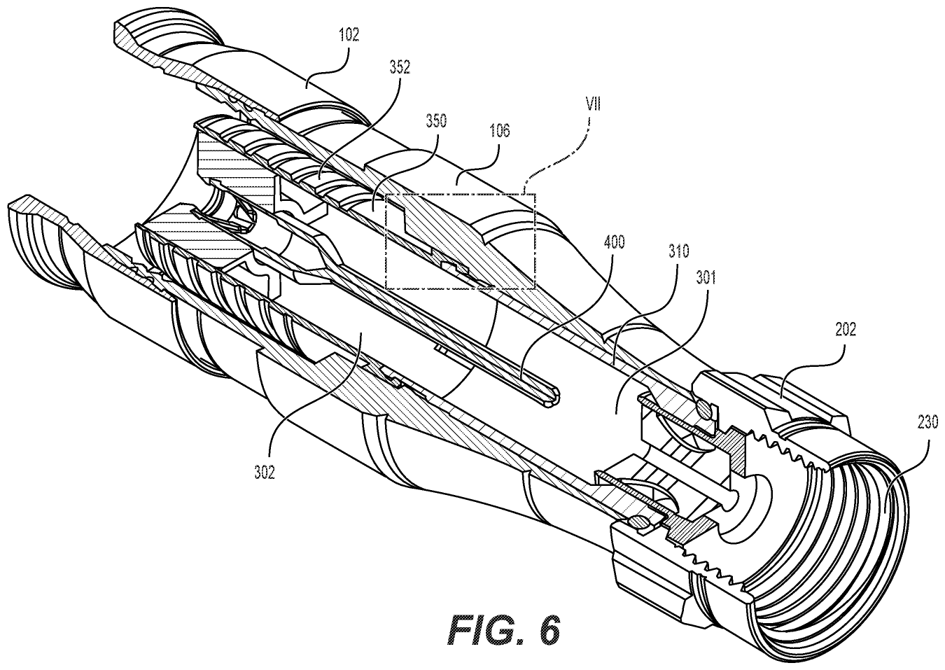

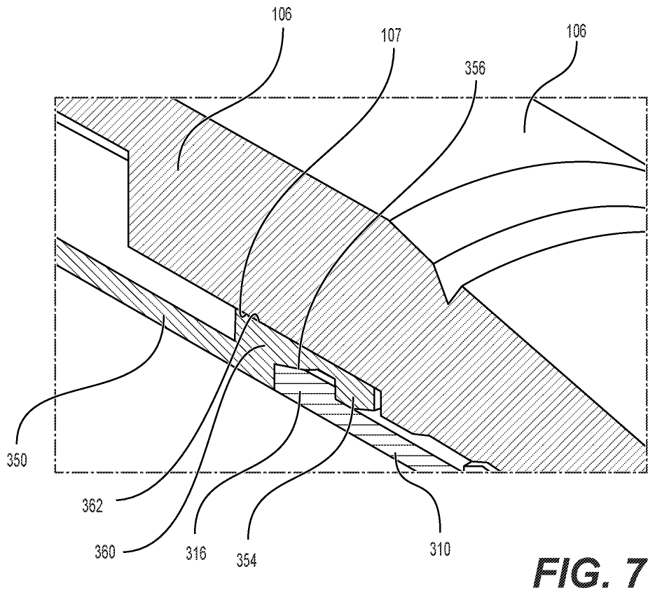

FIG. 6 shows a perspective sectional view of the connector assembly before the coaxial cable 1000 is inserted into connector 100. FIG. 7 shows an enlarged view of the area marked VII in FIG. 6. The forward portion 310 and the rearward portion 350 of the post 300 are show located in the nose portion 106 such that an inner surface 107 of the nose portion 106 contacts (or is in close proximity to) an outer surface 362 of an outer flange 360 of the rearward portion 350. This contact (or close proximity) prevents an engagement feature between the forward portion 310 and the rearward portion 350 from disengaging. For example, an engagement protrusion 316 on forward portion 310 is prevented from disengaging from an engagement recess 356 in rearward portion 350 (discussed in more detail, below). In embodiments, the inner surface 107 presses the knurling 317 into the engagement recess 356 to create a more positive engagement between the forward portion 310 and the rearward portion 350.

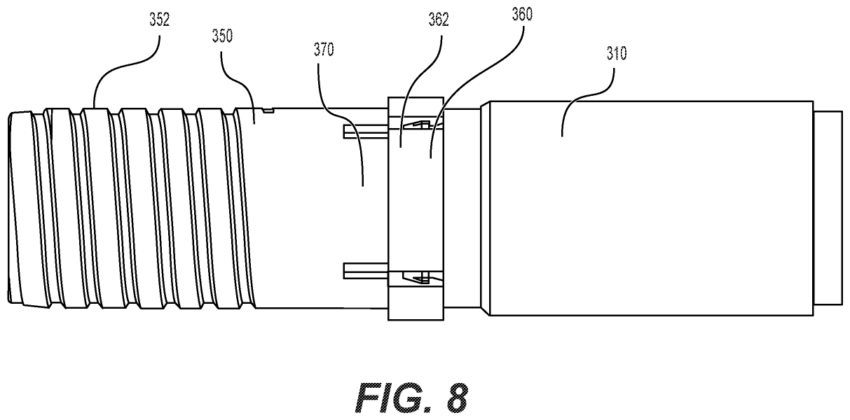

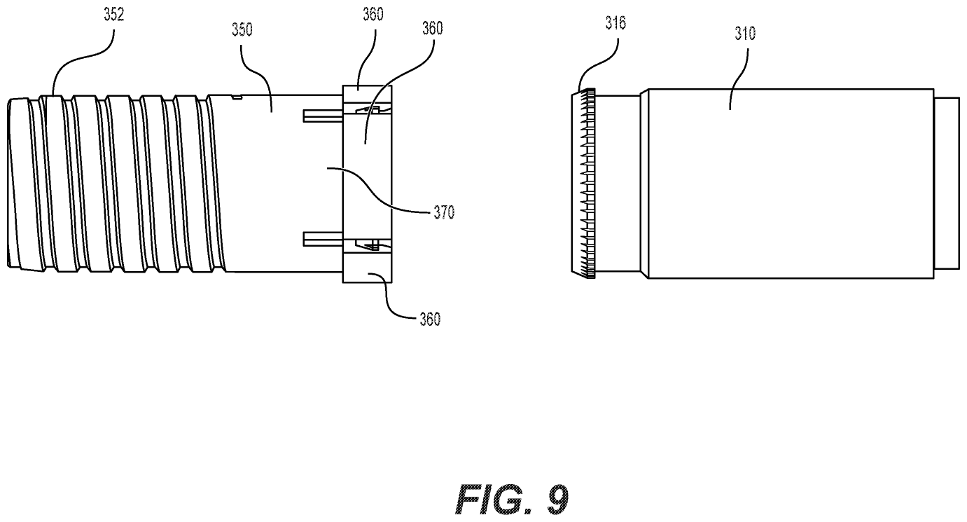

FIG. 8 is a side view showing the forward portion 310 and the rearward portion 350 in an attached state. FIG. 9 is a side view showing the forward portion 310 and the rearward portion 350 separated from one another.

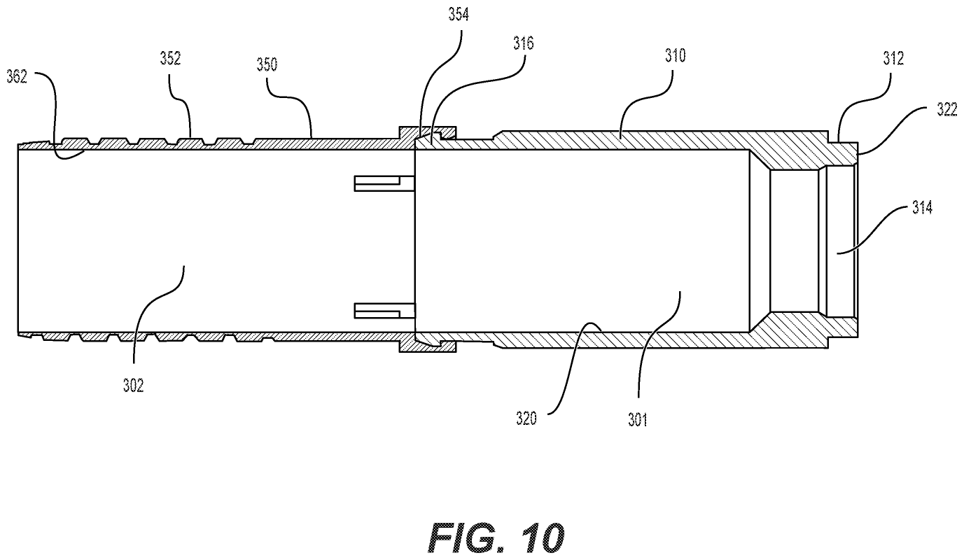

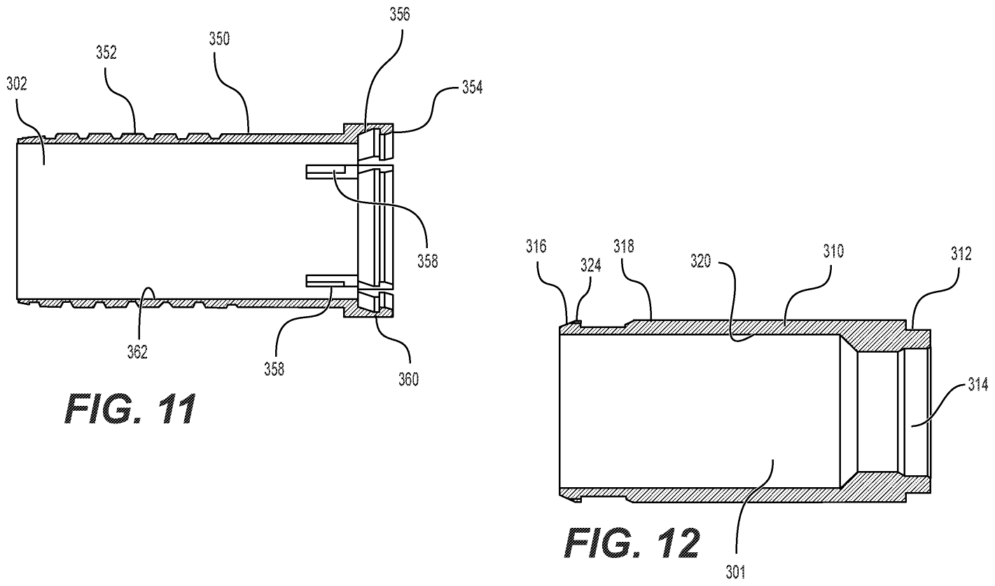

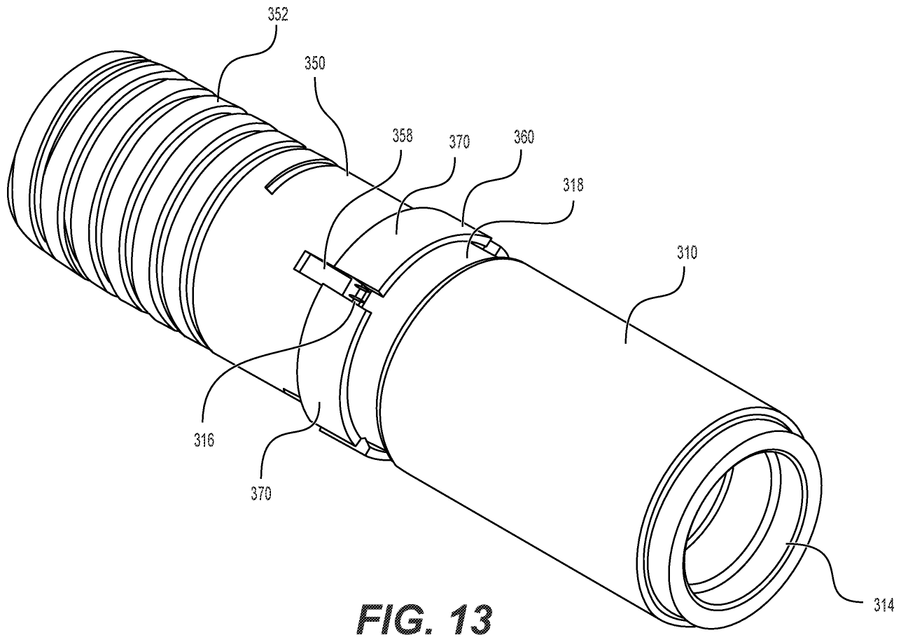

FIG. 10 shows a side sectional view of the forward portion 310 and the rearward portion 350 in an attached state. FIG. 11 shows a side sectional view of forward portion 310 separated from rearward portion 350, and FIG. 12 shows a side sectional view of rearward portion 350 separated from forward portion 310. The forward portion 310 has the engagement protrusion 316 that extends circumferentially around an outer surface 318 of the forward portion 310 and extends radially outward from the outer surface 318. The rearward portion 350 has the engagement recess 356 that extends circumferentially in an inner surface 362 of the rearward portion 350. The engagement recess 356 is formed, in part, by a lip 354 that extends in an inward radial direction. In an assembled state, the engagement protrusion 316 engages the engagement recess 356 such that the forward portion 310 and the rearward portion 350 are fixed axially relative to each other. Although the figures show the forward portion 310 having the engagement protrusion 316 and the rearward portion 350 having the engagement recess 356, it is noted that in other embodiments the forward portion 310 has an engagement recess the rearward portion 350 has an engagement protrusion. The engagement protrusion 316 engages the engagement recess 356 in a snap fit arrangement, providing a more secure and reliable connection that would be achieved by a press fit.

In embodiments, a knurled or other textured feature is provided where the forward portion 310 and the rearward portion 350 contact. For example, a knurling 317 is provided on engagement protrusion 316. In other embodiments, the knurled or other textured feature is located on a different area of the forward portion 310 and/or the rearward portion 350 in order to prevent relative rotation between the forward portion 310 and the rearward portion 350. The knurled or other textured feature resists rotation of the rearward portion 350 relative to the forward portion 310. Preventing rotation of the rearward portion 350 relative to the forward portion 310 can facilitate the insertion of the coaxial cable into the connector 100.

The axial bore 301 of the forward portion 310 has an inner surface 320, and the axial bore 302 of the rearward portion 350 has an inner surface 362. As shown in FIG. 10, the axial bores 301 and 302 have the same diameter such that the inner surfaces 320 and 362 align with each other. Aligning the inner surfaces 320 and 362 promotes maintaining a consistent electrical resistance of the forward portion 310 and the rearward portion 350. For example, the forward portion 310 and the rearward portion 350 both have an electrical resistance of 75 ohms.

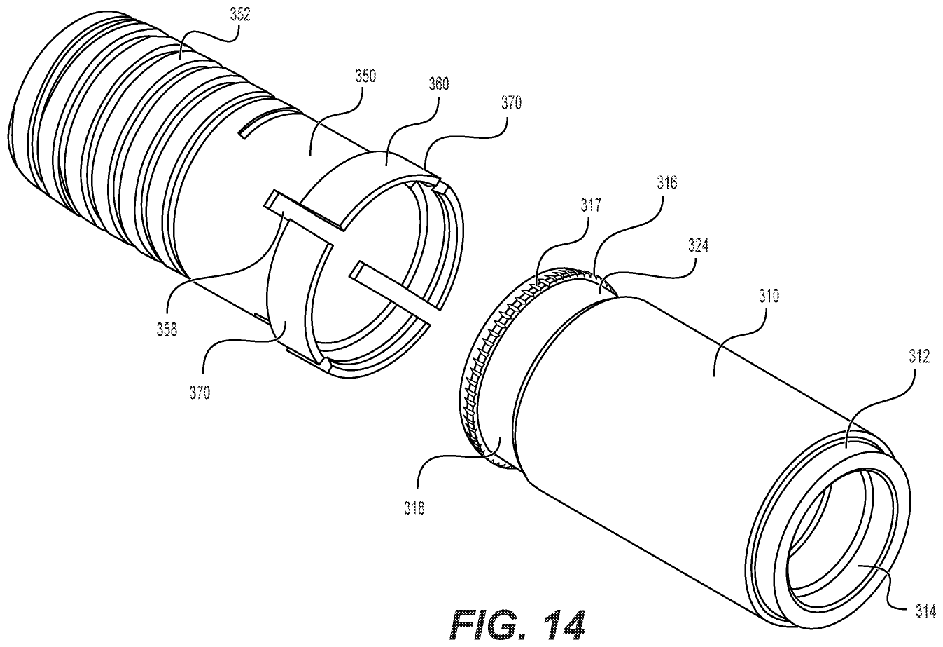

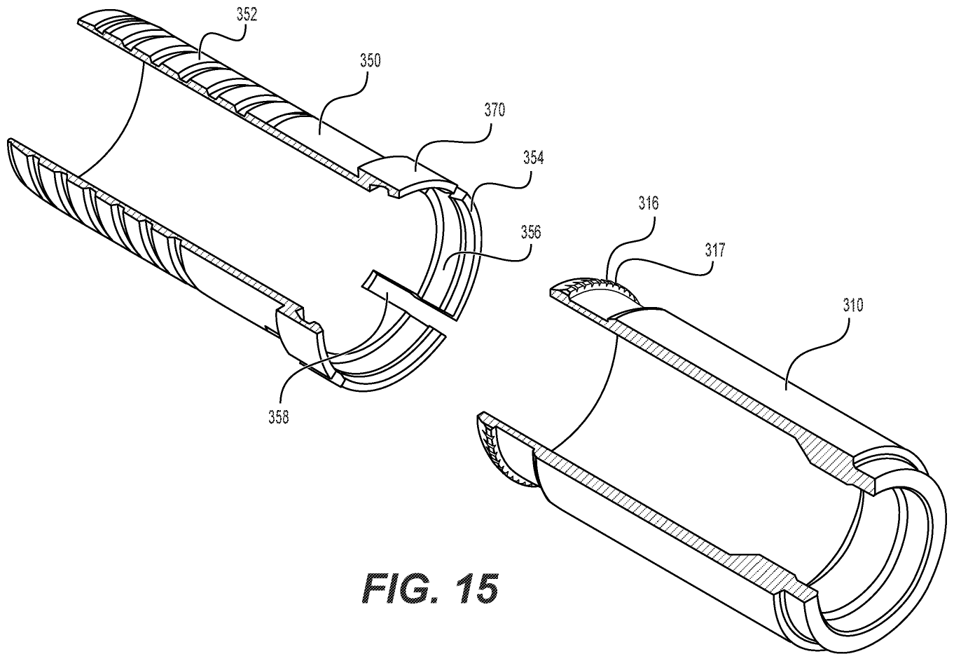

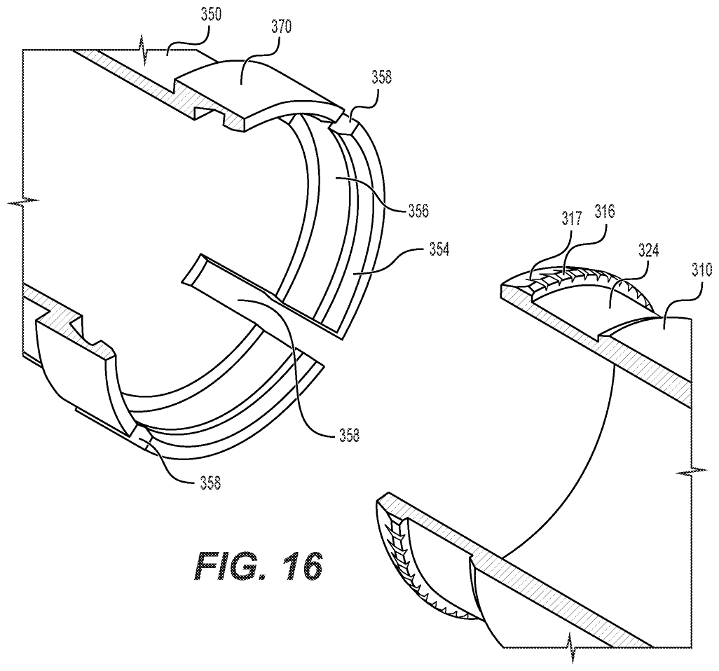

FIG. 11 shows rearward portion 350 having a number of slots 358 (also shown in FIGS. 13-17) that result in a number of flexible sections 370 (see FIGS. 13 and 14). The example shown in the figures has four of the slots 358 and, accordingly, four of the flexible sections 370. Other embodiments have fewer or more of the slots 358 and the flexible sections 370. The slots 358 allow the flexible sections 370 to flex outwardly in a radial direction to allow the flexible sections 370, and thus the lip 354, to fit over engagement protrusion 316 during assembly of the rearward section 350 to the forward section 310. In this example, the lip 354 (and the engagement recess 356) is separated into four pieces, which is the same number as the number of the flexible sections 370. Flexible sections 370 each have an outer flange 360 in the region of the lip 354 and the engagement recess 356.

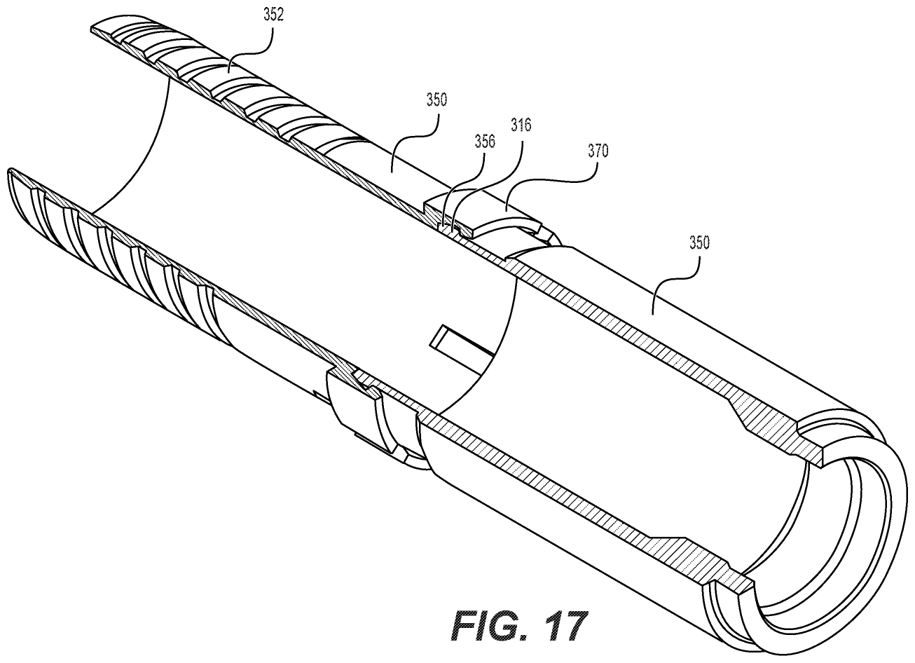

FIG. 13 is a perspective view showing the forward portion 310 and the rearward portion 350 in an assembled state. FIG. 14 is a perspective view showing the forward portion 310 and the rearward portion 350 in an unassembled state. FIGS. 14-16 show the knurling 317 that is provided on a perimeter of engagement protrusion 316. FIG. 17 shows the forward portion 310 and the rearward portion 350 in a connected state.

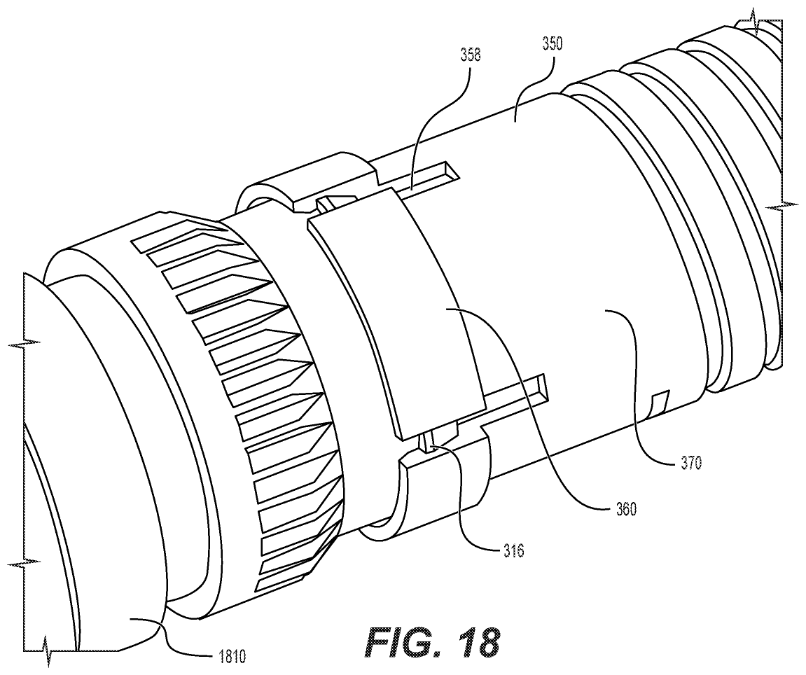

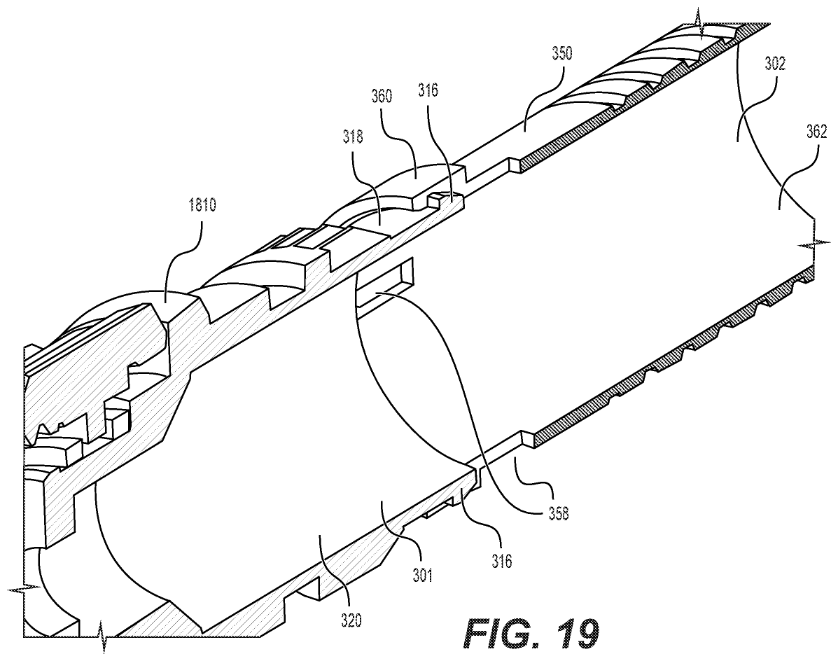

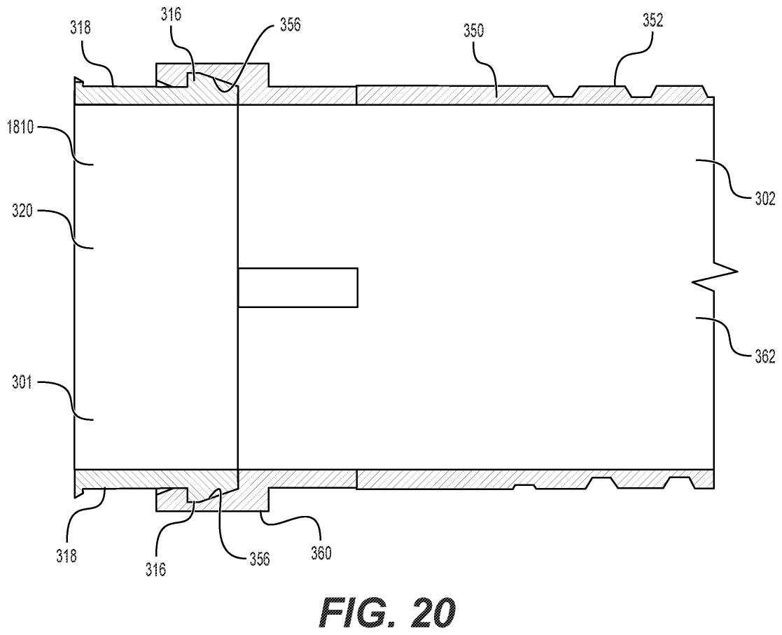

FIG. 18 is a partial perspective view showing an alternate embodiment having a forward portion 1810 and the rearward portion 350 in an assembled state. FIG. 19 is a partial perspective sectional view showing the embodiment shown in FIG. 18 in an assembled state. FIG. 20 is a partial side sectional view showing the forward portion 1810 and the rearward portion 350 in an assembled state.

The described embodiments provide various advantages including a simple and reliable two-piece post that provides a secure conductivity path from the outer conductor of the coaxial cable to the coupler 200.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. A coaxial connector that may include a forward engagement portion that may be configured to engage a rearward engagement portion so as to provide an electrical ground path between the forward engagement portion and the rearward engagement portion that may extend from an outer conductor of a coaxial cable through the forward and rearward engagement portions and to a post portion of the connector, comprising:
a connector body that may have a rearward cable receiving end and a forward end opposite the rearward cable receiving end;
a coupler that may be configured to be coupled with the forward end of the connector body;
a post portion that may be supported in at least a portion of the connector body;
wherein the post portion may comprise a forward post portion and a rearward post portion;
wherein the forward post portion and the rearward post portion may be configured to be coupled to one another so as to provide an electrical ground path between the forward post portion and the rearward post portion;
wherein the forward post portion may comprise a forward post engagement portion, and the rearward post portion may comprise a rearward post engagement portion;
wherein the forward post engagement portion may be configured to engage the rearward post engagement portion such that the forward post portion and the rearward post portion may be fixed relative to each other;
wherein the forward post engagement portion may be configured to extend circumferentially around at least a portion of the forward post portion;
wherein the rearward post engagement portion may be configured to extend from the rearward post portion;
wherein the rearward post portion may have a rearward post anti-rotation feature;
wherein the forward post portion may have a forward post anti-rotation feature that may be configured to engage the rearward post anti-rotation feature so as to restrain the rearward post portion from rotating relative to the forward post portion;
wherein the forward post portion may include a main portion that has an inner forward post surface that is configured such that a forward inner circumference of the inner forward post surface of the main portion of the forward portion is equal to a rearward inner circumference of an inner rearward post surface of a main portion of the rearward post portion;
wherein the rearward post portion may include a cable engagement feature on an outer circumference of the rearward post portion that is configured to engage a cable received in the cable receiving end of the connector body;
wherein the forward post engagement portion may be configured to engage the rearward post engagement portion so as to provide the electrical ground path between the forward post engagement portion and the rearward post engagement portion so as to provide a ground path from an outer conductor of a coaxial cable through the forward and rearward post engagement portions and to the post portion.

2. The coaxial connector of claim 1, wherein the forward engagement portion may comprise an engagement protrusion.

3. The coaxial connector of claim 2, wherein the rearward engagement portion may comprise an engagement recess.

4. The coaxial connector of claim 1, wherein the forward engagement portion may be configured to extend circumferentially around at least an outer surface portion of the forward post portion and extend radially outward from the outer surface of the forward post portion, and the rearward post engagement portion may be configured to extend circumferentially relative to an inner surface of the rearward portion.

5. The coaxial connector of claim 1, wherein the rearward engagement portion may comprise a plurality of flexible sections that are configured to flex in a radial direction.

6. The coaxial connector of claim 1, wherein the rearward engagement portion may include a flexible section that is configured to flex radially outward, and the flexible section may comprise a plurality of flexible sections that each may be separated in a circumferential direction by a plurality of slots.

7. The coaxial connector of claim 6, wherein the flexible section may be configured to flex in a radial direction so as to allow the rearward post engagement portion to move radially over the forward post engagement portion into a fully engaged position with the forward post engagement portion.

8. The coaxial connector of claim 1, wherein the ground path from an outer conductor of a coaxial cable through the forward and rearward post engagement portions and to the post portion may comprise a continuous ground path and/or a non-intermittent ground path.

9. A coaxial connector having a forward engagement portion configured to engage a rearward engagement portion to provide an electrical ground path between the forward engagement portion and the rearward engagement portion that may extend from an outer conductor of a coaxial cable through the forward and rearward engagement portions and to a post portion of the connector, comprising:
a connector portion having a rearward cable receiving end and a forward end opposite the rearward cable receiving end;
a coupler portion configured to be coupled with the forward end of the connector portion;
a post portion that is configured to supported in at least a portion of the connector portion and comprising a forward post portion and a rearward post portion;
wherein a connection between the forward post portion and the rearward post portion may be configured to provide an electrical ground path between the forward post portion and the rearward post portion;
wherein the forward post portion comprises a forward engagement portion that is configured to engage a rearward engagement portion of the rearward post portion such that the forward post portion and the rearward post portion are fixed relative to each other;
wherein a forward inner circumference of a forward inner surface of a main portion of the forward post portion is equal to a rearward inner circumference of a rearward inner surface of a main portion of the rearward post portion; and
wherein the forward engagement portion is configured to engage the rearward engagement portion to provide the electrical ground path between the forward engagement portion and the rearward engagement portion so as to provide a ground path from an outer conductor of a coaxial cable through the forward and rearward engagement portions and to the post portion.

10. The coaxial connector of claim 9, wherein the forward post engagement portion may be configured to extend circumferentially around at least a portion of the forward post portion.

11. The coaxial connector of claim 10, wherein the rearward post engagement portion may be configured to extend from the rearward post portion.

12. The coaxial connector of claim 9, wherein the rearward post portion may have a rearward post anti-rotation feature, and the forward post portion may have a forward post anti-rotation feature that may be configured to engage the rearward post anti-rotation feature so as to restrain the rearward post portion from rotating relative to the forward post portion.

13. The coaxial connector of claim 9, wherein the rearward post portion may include a cable engagement feature on an outer circumference of the rearward post portion that is configured to engage a cable received in the cable receiving end of the connector body.

14. The coaxial connector of claim 9, wherein the forward post engagement portion may include an engagement protrusion, and the rearward post engagement portion may include an engagement recess.

15. The coaxial connector of claim 9, wherein the rearward post engagement portion may comprise a plurality of flexible sections that are configured to flex in a radial direction, and the plurality of flexible sections may be separated in a circumferential direction by a plurality of slots.

16. The coaxial connector of claim 9, wherein the flexible sections may be configured to flex in the radial direction so as to allow the rearward post engagement portion to move radially over the forward post engagement portion into a fully engaged position with the forward post engagement portion.

17. The coaxial connector of claim 9, wherein the ground path from an outer conductor of a coaxial cable through the forward and rearward post engagement portions and to the post portion may comprise a continuous ground path and/or a non-intermittent ground path.

18. A coaxial connector having a forward engagement portion configured to engage a rearward engagement portion to provide an electrical ground path between the forward engagement portion and the rearward engagement portion that may extend from an outer conductor of a coaxial cable through the forward and rearward engagement portions and to a post portion of the connector, comprising:
a connector portion;
a coupler portion configured to be coupled with the connector portion;
a post portion comprising a forward post portion and a rearward post portion;
wherein a connection between the forward post portion and the rearward post portion may be configured to provide an electrical ground path;
wherein the forward post portion comprises a forward post engagement portion that is configured to engage a rearward post engagement portion of the rearward post portion such that the forward post portion and the rearward post portion are fixed relative to each other; and
wherein the forward post engagement portion may be configured to engage the rearward post engagement portion so as to provide the electrical ground path between the forward post engagement portion and the rearward post engagement portion so as to provide a ground path from an outer conductor of a coaxial cable through the forward and rearward post engagement portions and to the post portion.

19. The coaxial connector of claim 18, wherein a forward inner circumference of a forward inner surface of a main portion of the forward post portion is equal to a rearward inner circumference of a rearward inner surface of a main portion of the rearward post portion.

20. The coaxial connector of claim 18, wherein the rearward post portion has a rearward anti-rotation feature; and the forward post portion has a forward anti-rotation feature that engages the rearward anti-rotation feature so as to restrain the rearward post portion from rotating relative to the forward post portion.

21. The coaxial connector of claim 18, wherein the rearward post engagement portion may comprise a plurality of flexible sections that are configured to flex in a radial direction, and the plurality of flexible sections may be separated in a circumferential direction by a plurality of slots.

22. The coaxial connector of claim 21, wherein the flexible sections may be configured to flex in the radial direction so as to allow the rearward post engagement portion to move radially over the forward post engagement portion into a fully engaged position with the forward post engagement portion.

23. The coaxial connector of claim 18, wherein the ground path from an outer conductor of a coaxial cable through the forward and rearward post engagement portions and to the post portion may comprise a continuous ground path and/or a non-intermittent ground path.
